(19) United States
(12) Patent Application Publication
(10) Pub. No.: US 2014/0183179 A1
(43) Pub. Date: Jul. 3, 2014

(54) COOKING DEVICE

(71) Applicant: TSANN KUEN (ZHANGZHOU) ENTERPRISE CO., LTD., Zhang Zhou (CN)

(72) Inventor: Yu-Cheng CHEN, Keelung City (TW)

(73) Assignee: TSANN KUEN (ZHANGZHOU) ENTERPRISE CO., LTD., Zhang Zhou (CN)

(21) Appl. No.: 14/141,679

(22) Filed: Dec. 27, 2013

(30) Foreign Application Priority Data
Dec. 27, 2012 (CN) 201210578507.6

(51) Int. Cl. A47J 36/34; F24C 15/10

(52) U.S. Cl. CPC A47J 36/34; F24C 15/103
USPC 219/434; 219/453.12

(57) ABSTRACT

A cooking device includes a base and a cooking container assembled to the base. The base includes a fixing base and at least a first height adjustable heating component. The first heating component is disposed with a first heating source and is movably assembled to the fixing base. The first heating component is movably assembled to the fixing base, thus making the position of the first heating resource adjustable. The position of the first heating source is adjusted according to the position of the bottom surface of the cooking container, so that the first heating source is close to the bottom surface of the cooking container, thus heating the cooking container equally and with deformation resistance.

### FIELD OF THE INVENTION

The present invention relates to a cooking device.

### BACKGROUND OF THE INVENTION

Existing cooking device has its heating component fixed to the base, the cooking container is easy to deform after heated, due to the rigidity of the heating component, the heating component is no longer to closely contact to the bottom surface of the cooking container, thus making the cooking container heated unequally and then easy to deform, the food is heated unequally as well, it may be partly burning and partly underdone, moreover it losses much heat of the heating component, which is a waste of resource and thus increase the cost.

Existing cooking device has its cooking container unable to separate, so that if the cooking container deforms due to unequally heated, it can not change, thus making the whole cooking device failed to be used. In other case, although the cooking container is detachable to the base, the cooking container has only one front side to cook, the back side can not be used, it is a waste of resource.

### SUMMARY OF THE INVENTION

The present invention is provided with a cooking device, which overcomes the disadvantages of the existing technology. The technical proposal of the present invention is as below:

A cooking device, comprising a base (100) and a cooking container assembled to the base (100), wherein the base (100) comprising a fixing base (110) and at least a first heating component (120) of height adjustable, the first heating component (120) is disposed with a first heating source (121) and is movably assembled to the fixing base (110).

In another preferred embodiment, the base (100) further comprising at least a second heating component (130), the second heating component (130) is disposed with a second heating source (131) and is assembled to the fixing base (110) or the first heating component (120).

In another preferred embodiment, the second heating component (130) is disposed at the interior of the first heating component (120) and is movably assembled to the fixing base (110) or the first heating component (120).

In another preferred embodiment, the first heating component (120) is slideably assembled to the fixing base (110) up and down, the second heating component (130) is slideably assembled to the first heating component (120).

In another preferred embodiment, the first heating component (120) further comprising an annular first connecting base (122) and at least a first elastic element (123), the first heating source (121) is fixed to the top end face of the first connecting base (122), the external periphery of the first connecting base (122) is disposed with an annular first hem (124), an annular first groove (125) is formed between the first hem (124) and the first connecting base (122), the internal periphery of the fixing base (110) is disposed with an annular first flange (111), the first connecting base (122) extends into the fixing base (110) and the first flange (111) is situated in the first groove (125) and is locked to the first groove (125), the first elastic element (123) abuts between the first connecting base (122) and the fixing base (110).

In another preferred embodiment, the second heating component (130) further comprising a second connecting base and at least a second elastic element (133), the second heating source (131) is fixed to the top end face of the second connecting base (132), the external periphery of the second connecting base (132) is disposed with an annular second hem (134), an annular second groove (135) is formed between the second hem (134) and the second connecting base (132), the internal periphery of the first connecting base (122) is disposed with an annular second flange (126), the second connecting base (132) extends into the first connecting base (122) and the second flange (126) is situated in the second groove (135) and is locked to the second groove (135), the second elastic element (133) abuts between the second connecting base (132) and the fixing base (110).

In another preferred embodiment, the fixing base (110) comprising a lower housing (112) and an upper housing (113) fixed to the lower housing (112), the first flange (111) is disposed in the upper housing (113).

In another preferred embodiment, the cooking container is a baking pan (200), the bottom surface thereof is flat, curved, waved or stepped.

In another preferred embodiment, the baking pan (200) is disposed with a front side and a back side opposite to the front side, the front side and the back side of the baking pan (200) are separable to assemble to the fixing base (110), the front side and the back side are able to contact to the first heating source (121) and the second heating source (131).

In another preferred embodiment, it comprising one first heating component (120) and one second heating component (130).

In another preferred embodiment, it comprising one first heating component (120) and two second heating components (130), the two second heating components (130) are an internal second heating component (130a) and an external second heating component (130b), the external second heating component (130b) is movably assembled to the first heating component (120), the internal second heating component (130a) is situated inside the external second heating component (130b) and is movably assembled to the first heating component (120) by the external heating component (130b).

In another preferred embodiment, the cooking container is a pan.

Compared to the existing technology, the technical proposal of the present invention has advantages as below:

1. The first heating component is movably assembled to the fixing base, thus making the position of the first heating resource adjustable, the position of the first heating source is adjusted according to the position of the bottom surface of the cooking container, thus making the first heating source closely contacted to the bottom surface of the cooking container, thus making the cooking container heated equally and with deformation resistance. If the cooking container deforms after long time used, the first heating component can automatically adjust its position so that the first heating resource will be closely contacted to the cooking container, thus reducing heat loss.

2. The second heating component is movably assembled to the fixing base or the first heating component, thus making the bottom surface of the cooking container more closely contacted to the heating source, thus making it heated more equally.

3. With the cooperation of the first flange and the first groove and under the work of the first elastic element, the first connecting base is slideably assembled to the fixing base up and down, the structure is simple with low cost.

4. With the cooperation of the second flange and the second groove and under the work of the second elastic element, the second connecting base is slideably assembled to the first connecting base up and down, the structure is simple with low cost.

5. The front and back sides of the baking pan are detachably assembled to the fixing base, the front and back sides are contacted to the first heating source and the second heating source, so that the front and back sides of the baking pan are able to barbecue, which makes good used of resource and is of cost reduction.

6. The cooking container is a pan, thus making the cooking device multi-functional.

### BRIEF DESCRIPTION OF THE DRAWINGS

The present invention will be further described with the drawings and the embodiments.

FIG. 1 illustrates a first schematic and exploded diagram of the cooking device of the first embodiment.

FIG. 2 illustrates a second schematic and exploded diagram of the cooking device of the first embodiment.

FIG. 3 illustrates a schematic and exploded diagram of the second heating component of the cooking device of the first embodiment. FIG. 4 illustrates a schematic and exploded diagram of the first heating component of the cooking device of the first embodiment.

FIG. 5 illustrates a sectional view of the cooking device of the first embodiment when it is assembled without the baking pan.

FIG. 6 illustrates a sectional view of the cooking device of the first embodiment when the back side of the baking pan is cooperated to the base.

FIG. 7 illustrates a sectional view of the cooking device of the first embodiment when the front side of the baking pan is cooperated to the base.

FIG. 8 illustrates a sectional view of the cooking device of the second embodiment when it is assembled without the baking pan.

FIG. 9 illustrates a sectional view of the cooking device of the second embodiment when the back side of the baking pan is cooperated to the base.

FIG. 10 illustrates a sectional view of the cooking device of the second embodiment when the front side of the baking pan is cooperates to the base.

FIG. 11 illustrates a sectional view of the cooking device of the third embodiment when the large stew pot is cooperated to the base.

FIG. 12 illustrates a sectional view of the cooking device of the fourth embodiment when the small stew pot is cooperated to the base.

### DETAILED DESCRIPTION OF THE EMBODIMENTS

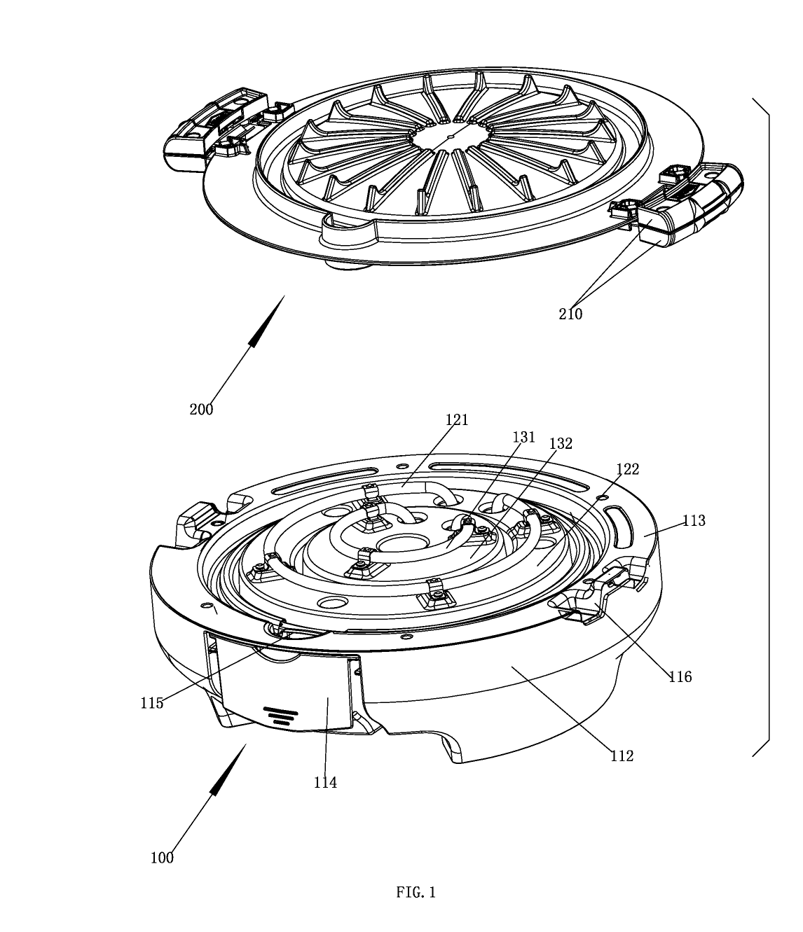

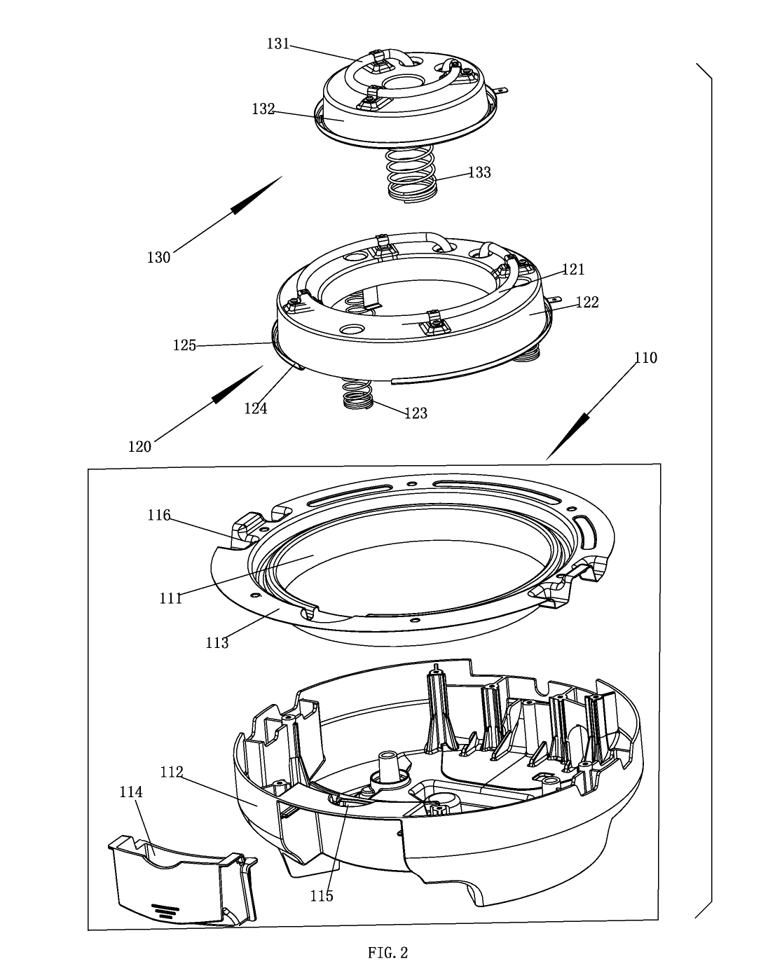

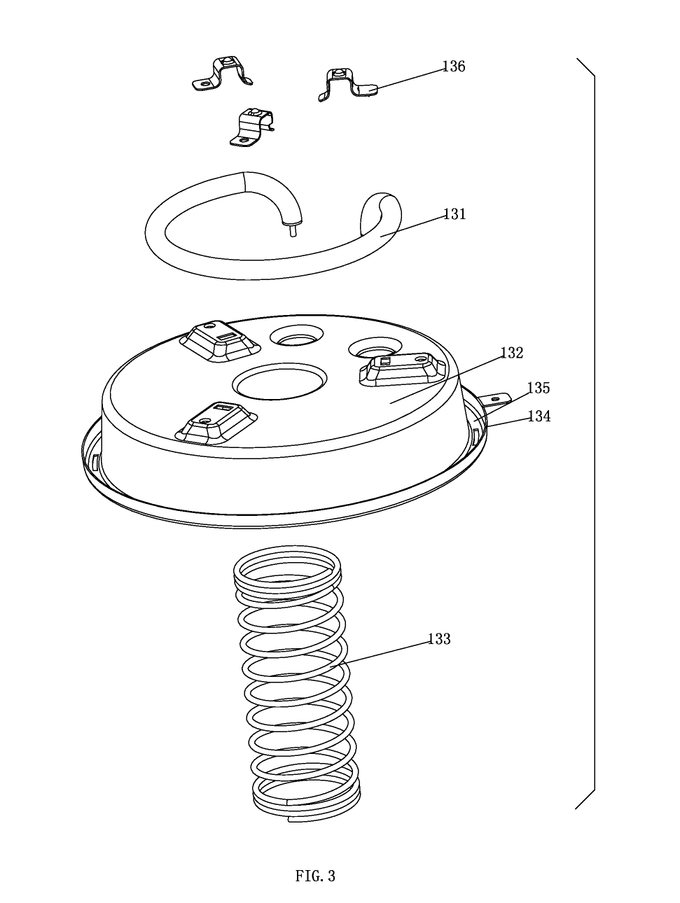

Please refer to FIG. 1 to FIG. 7, a cooking device of the first embodiment comprising a base 100 and a cooking container assembled to the base 100.

The base 100 comprising a fixing base 110 and at least a first heating component 120.

The internal periphery of the fixing base 110 is disposed with an annular first flange 111. In this embodiment, the fixing base 110 comprising a lower housing 112 and an upper housing 113 fixed to the lower housing 112, the first flange 111 is fixed to the upper housing 113. In this embodiment, the external periphery of the lower housing 112 is assembled with an oil box 114, the upper housing 113 is disposed with an oil hole 115 corresponding to the oil box 114. In this embodiment, two assembly portions 116 are disposed at the top surface of the upper housing 113.

The first heating component 120 is height adjustable, and it has a first heating source 121 and is movably assembled to the fixing base 110. The position of the first heating source 121 is adjustable according to the position of the bottom surface of the cooking container, thus making the first heating source closely contacted to the bottom surface of the cooking container, thus making the cooking container heated equally and with deformation resistance. If the cooking container deforms after long time used, the first heating component can automatically adjust its position so that the first heating resource will be closely contacted to the cooking container, thus reducing heat loss.

In this embodiment, there is one first heating component 120 and the first hating component 120 is slideably assembled to the fixing base 110 up and down. As needed, it can dispose several first heating components 120 according to the size of the cooking container. In this embodiment, the first heating component 120 further comprising an annular first connecting base 122 and at least a first elastic element 123, the first heating source 121 is fixed to the top end face of the first connecting base 122, the external periphery of the first connecting base 122 is disposed with an annular first hem 124, an annular first groove 125 is formed between the first hem 124 and the first connecting base 122. The first connecting base 122 extends into the fixing base 110 and the first flange 111 is situated in the first groove 125 and is locked to the first groove 125, the first elastic element 123 abuts between the first connecting base 122 and the fixing base 110. with the cooperation of the first flange 111 and the first groove 125 and under the work of the first elastic element 123, the first connecting base 122 can be slideably assembled to the fixing base 110 up and down, the structure is simple with low cost.

In this embodiment, the first hem 124 is fixed to the external periphery edge of the bottom of the first connecting base 122, there are three first elastic elements 123 and these three first elastic elements 123 are spaced disposed between the bottom of the first connecting base 122 and the fixing base 110. In this embodiment, the first heating source 121 is a heater strip, the first heating source 121 is locked to the top end face of the first connecting base 122 by several fixing pieces 127.

In this embodiment, the internal periphery of the first connecting base 122 is disposed with an annular second flange 126.

The base 100 further comprising at least a second heating component 130, the second heating component 130 is disposed with a second heating source 131, which is assembled to the fixing base 110 or the first heating component 120. In this embodiment, the second heating component 130 is disposed in the interior of the first heating component 120 and is movably assembled to the first heating component 120 or the fixing base 110. So that the bottom surface of the cooking container is more closely contacted to the heating source, thus making it heated equally.

In this embodiment, there is one second heating component 130, which is slideably assembled to the first heating component 120 up and down. In other case, as needed, it is disposed with several second heating components 130, which are corresponding to the first heating components 120 one by one, or it can dispose several second heating components 130 in the interior of the first heating component 120. For example, it can dispose with two second heating components 130, which are disposed inside the first heating component 120.

In this embodiment, the second heating component 130 further comprising a second connecting base 132 and at least a second elastic element 133, the second heating source 131 is fixed to the top end face of the second connecting base 132, the external periphery of the second connecting base 132 is disposed with an annular second hem 134, an annular second groove 135 is formed between the second hem 134 and the second connecting base 132. The second connecting base 132 extends into the first connecting base 122 and the second flange 126 is situated in the second groove 135 and is locked to the second groove 135, the second elastic element 133 abuts between the second connecting base 132 and the fixing base 110. with the cooperation of the second flange 126 and the second groove 135 and under the work of the second elastic element 133, the second connecting base 132 can be slideably assembled to the first connecting base 122 up and down, the structure is simple with low cost. Preferred, the height of the bottom of the second flange 126 is higher than that of the first flange 111.

In this embodiment, the second hem 134 is fixed to the external periphery edge of the bottom of the second connecting base 132, it is disposed with a second elastic element 133 and the second elastic element 133 abuts between the central of the bottom of the second connecting base 132 and the fixing base 110. In this embodiment, the second heating source 131 is a heater strip, the second heating source 131 is locked to the top end face of the second connecting base 132 by several fixing pieces 136.

In this embodiment, the cooking container is a baking pan 200, which is movably assembled to the base 100, the bottom surface of the baking pan 200 is curved. Or as needed, the bottom surface of the baking pan 200 can be flat, waved or stepped, but not limited.

In this embodiment, the baking pan 200 has a front side and a back side opposite to the front side, the front and back sides of the cooking pan 200 are detachably assembled to the fixing base 110, the front and back sides are able to contact to the first heating source 121 and the second heating source 131, so that the front and back sides of the baking pan are able to barbecue, which makes good used of resource and is of cost reduction.

In this embodiment, the external periphery of the front and back sides of the baking pan 200 are disposed with two lock portions 210 to cooperate with the assembly portions 116, with the cooperation of the lock portions 210 and the assembly portions 116, the baking pan 200 is face to the upper housing 113 or back against the upper housing 113 and then is assembled to the upper housing 113.

Please refer to FIG. 5 to FIG. 7, take for an example that the bottom surface of the baking pan 200 is curved, the front side and the back side of the baking pan 200 are detachably assembled to the fixing base 110, the front and back sides are able to contact to the first heating source 121 and the second heating source 131. The work principle is as below:

As figured in FIG. 5, it illustrates the initial state of the base 100 when the baking pan 200 is not yet assembled to the base 100, the first flange 111 is locked to the first groove 125, the second flange 126 is locked to the second groove 135, the height of the second heating component 130is higher than that of the first heating component 120.

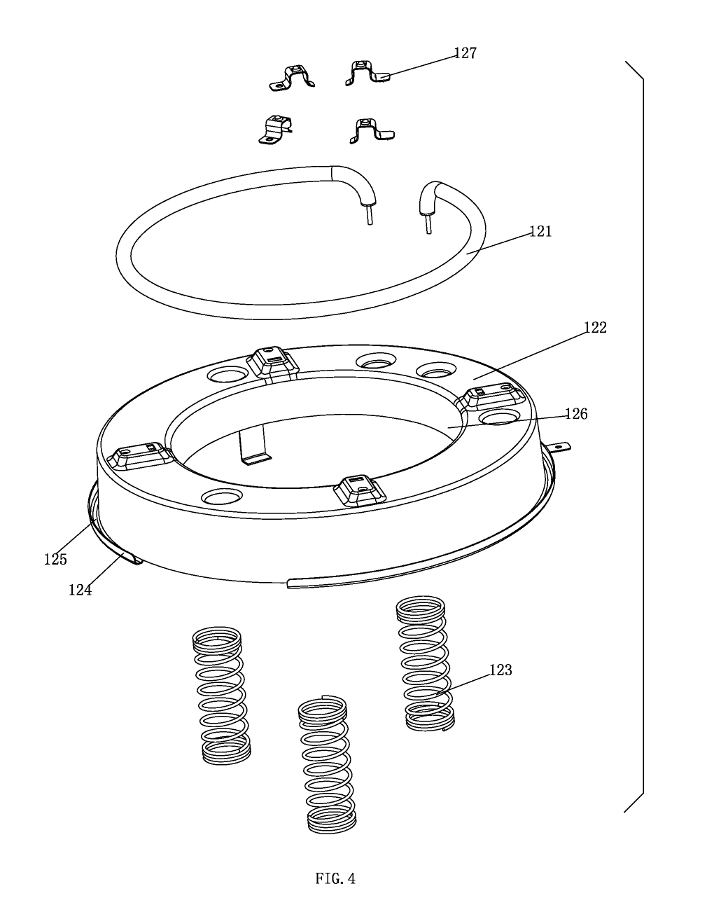

As figured in FIG. 6, the front side of the baking pan 200 is faced up, it is a protruded upward curved surface when looking from up to down, that is to say, the height of the center of the baking pan 200 is higher than that around, the back side of the baking pan 200 is contacted to the first heating source 121 and the second heating source 131, the lock portions 210 of the back side is cooperated to the assembly portions 116 of the upper housing 113 to assemble the baking pan 200 and the upper housing 113 together.

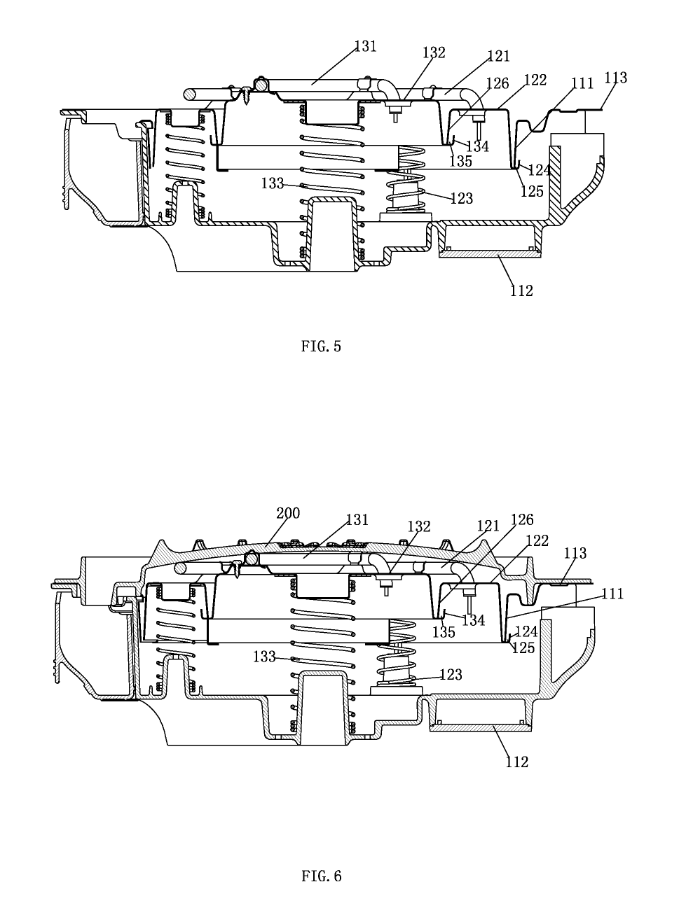

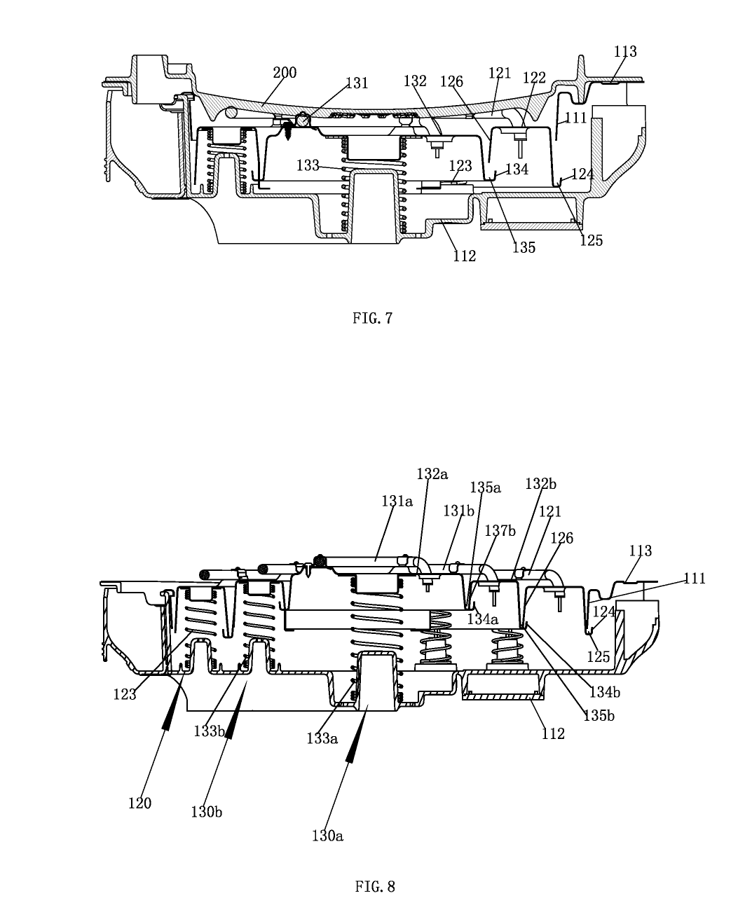

As figured in FIG. 7, the cooking pan 200 is the one in FIG. 6, the back side of the baking pan 200 is faced up, it is a protruded downward curved surface when looking from up to down, that is to say, the height of the center of the baking pan 200 is lower than that around, when the front side of the baking pan 200 is faced down on the fixing base 110, under the work of the gravity of the baking pan 200, the first elastic element 123 and the second elastic element 133 contract till the front side of the baking pan 200 is totally contacted to the first heating source 121 and the second heating source 131, with the cooperation of the lock portions 210 of the baking pan 200 and the assembly portions 116 of the upper housing 113, the baking pan 200 is assembled to the upper housing 113.

The first heating component 120 is movably assembled to the fixing base 110, the second heating component 130 is movably assembled to the first heating component 120, thus making the positions of the first heating source 121 and the second heating source adjustable, thus adjusting the positions of the first heating source 121 and the second heating source 131 on the basis of the shape of the bottom of the baking pan 200, thus making the first heating source 121 and the second heating source 131 closely contacted to the bottom surface of the baking pan 200, thus making the baking pan 200 heated equally and not easy to deform. When the baking pan 200 deforms after long time used, the second heating component 130 and the first heating component 120 can automatically adjust the position themselves to make the first heating source 121 and the second heating source 131 closely contacted to the baking pan, thus reducing the loss of heat. Meanwhile, the cooking device is available to apply in most of the baking pans, thus making it with wide applicability, thus satisfying the consumers' needs.

As figured in FIG. 8 to FIG. 12, the figures illustrate a second embodiment of the cooking device, the difference from the first embodiment is that, there is one first heating component 120 and two second heating components, an internal second heating component 130a and an external second heating component 130b, the external second heating component 130b is movably assembled to the interior of the first heating component 120, the internal second heating component 130a is situated in the interior of the second heating component 130b and is movably assembled to the first heating component 120 by the external second heating component 130b.

In this embodiment, the internal second heating component 130a comprising an internal second heating source 131a, an internal second connecting base 132a and at least an internal second elastic element 133a, the internal second heating source 131a is fixed to the top end face of the internal second connecting base 132a, the external periphery of the internal second connecting base 132a is disposed with an annular internal second hem 134a, an annular internal second groove 135a is formed between the internal second hem 134a and the internal second connecting base 132a.

In this embodiment, the external second heating component 130b comprising an external second heating source 131b, an external second connecting base 132b and at least an external second elastic element 133b, the external second heating source 131b is fixed to the top end face of the external second connecting base 132b, the external periphery of the external second connecting base 132b is disposed with an annular external second hem 134b, an annular external second groove 135b is formed between the external second hem 134b and the external second connecting base 132b. The external second connecting base 132b is further disposed with a third flange 137b.

In this embodiment, the structure of the first heating component 120 is similar to the first embodiment. The third flange 137b is situated in the external second groove 135b and is locked to the external second groove 135b, the second flange 126 is situated in the external second groove 135b and is locked to the external second groove 135b, the first flange 111 is situated in the first groove 125 and is locked to the first groove 125.

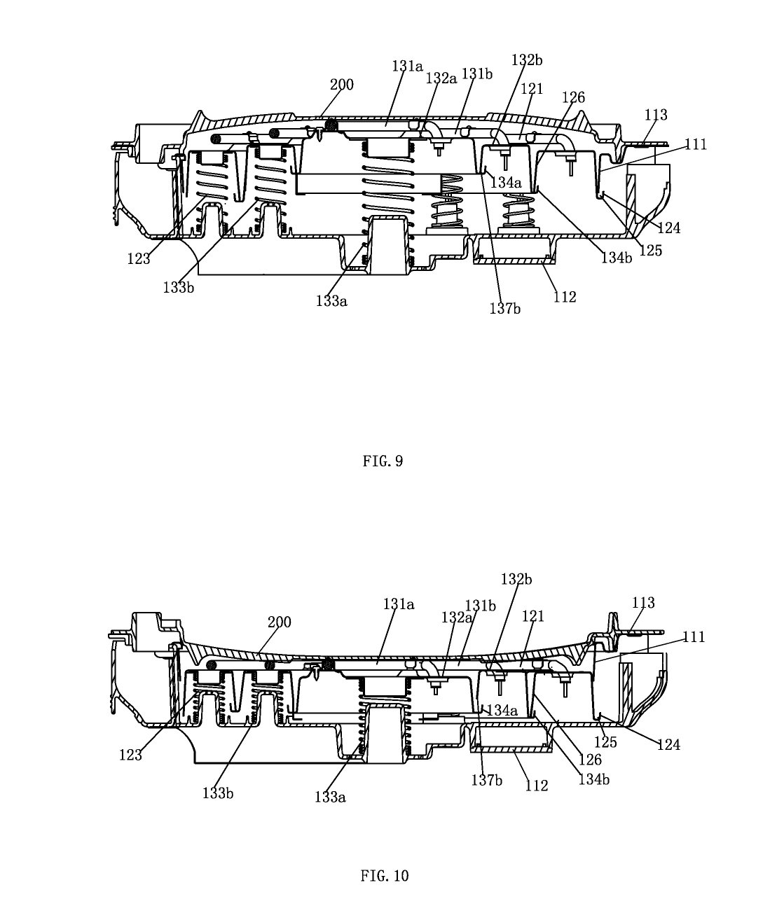

As figured in FIG. 9 and FIG. 10, a cooking container 200 with a curved bottom surface is placed on the base 100, the front and back sides of the cooking container are detachably assembled to the fixing base 110, the front and back sides are contacted to the first heating source 121, the internal second heating source 131a and the external second heating source 131b.

As figured in FIG. 11, the cooking container of the third embodiment is a pan, can be a frying pan or a saucepot. In this embodiment, the pan is a big saucepot 300 placed on the base 100, the first heating component 120, the external second heating component 130b and the internal second heating component 130a are placed under the bottom surface of the big saucepot 300.

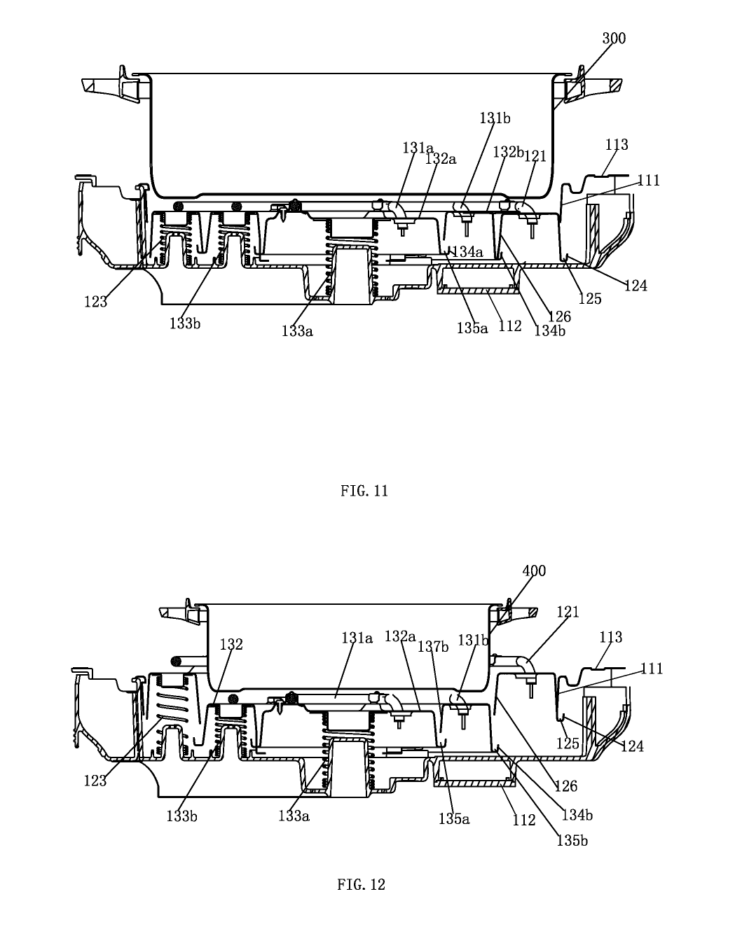

As figured in FIG. 12, the cooking container of the fourth embodiment is a pan, it is a small saucepot 400, the small saucepot 400 is on the base 100, as the small saucepot 400 is small in size, so that the internal second heating component 130a and the external second heating component 130b are always under the small saucepot 400, the first heating component 120 is surrounded the small saucepot 400 unaffected by the gravity of the small saucepot 400, so that the small saucepot 400 is heated more equally. According to the size of the pan, it can dispose three second heating components 130 or more.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. A cooking device Comprising:
a base (100); and
a cooking container assembled to the base (100);
wherein the base (100) comprising a fixing base (110) and at least a first heating component (120) of height adjustable, the first heating component (120) is disposed with a first heating source (121) and is movably assembled to the fixing base (110).

2. The cooking device according to claim 1, wherein the base (100) further comprising at least a second heating component (130), the second heating component (130) is disposed with a second heating source (131) and is assembled to the fixing base (110) or the first heating component (120).

3. The cooking device according to claim 2, wherein the second heating component (130) is disposed at the interior of the first heating component (120) and is movably assembled to the fixing base (110) or the first heating component (120).

4. The cooking device according to claim 3, wherein the first heating component (120) is slideably assembled to the fixing base (110) up and down, the second heating component (130) is slideably assembled to the first heating component (120).

5. The cooking device according to claim 2, wherein the first heating component (120) further comprising an annular first connecting base (122) and at least a first elastic element (123), the first heating source (121) is fixed to the top end face of the first connecting base (122), the external periphery of the first connecting base (122) is disposed with an annular first hem (124), an annular first groove (125) is formed between the first hem (124) and the first connecting base (122), the internal periphery of the fixing base (110) is disposed with an annular first flange (111), the first connecting base (122) extends into the fixing base (110) and the first flange (111) is situated in the first groove (125) and is locked to the first groove (125), the first elastic element (123) abuts between the first connecting base (122) and the fixing base (110).

6. The cooking device according to claim 5, wherein the second heating component (130) further comprising a second connecting base and at least a second elastic element (133), the second heating source (131) is fixed to the top end face of the second connecting base (132), the external periphery of the second connecting base (132) is disposed with an annular second hem (134), an annular second groove (135) is formed between the second hem (134) and the second connecting base (132), the internal periphery of the first connecting base (122) is disposed with an annular second flange (126), the second connecting base (132) extends into the first connecting base (122) and the second flange (126) is situated in the second groove (135) and is locked to the second groove (135), the second elastic element (133) abuts between the second connecting base (132) and the fixing base (110).

7. The cooking device according to claim 5, wherein the fixing base (110) comprising a lower housing (112) and an upper housing (113) fixed to the lower housing (112), the first flange (111) is disposed in the upper housing (113).

8. The cooking device according to claim 7, wherein the cooking container is a baking pan (200), the bottom surface thereof is flat, curved, waved or stepped.

9. The cooking device according to claim 8, wherein the baking pan (200) is disposed with a front side and a back side opposite to the front side, the front side and the back side of the baking pan (200) are separable to assemble to the fixing base (110), the front side and the back side are able to contact to the first heating source (121) and the second heating source (131).

10. The cooking device according to claim 3, wherein comprising one first heating component (120) and one second heating component (130).

11. The cooking device according to claim 3, wherein comprising one first heating component (120) and two second heating components (130), the two second heating components (130) are an internal second heating component (130a) and an external second heating component (130b), the external second heating component (130b) is movably assembled to the first heating component (120), the internal second heating component (130a) is situated inside the external second heating component (130b) and is movably assembled to the first heating component (120) by the external heating component (130b).

12. The cooking device according to claim 11, wherein the cooking container is a pan.
